(19) United States
(12) Patent Application Publication
(10) Pub. No.: US 2016/0209709 A1
(43) Pub. Date: Jul. 21, 2016

(54) CURVED LIQUID CRYSTAL DISPLAY DEVICE

(71) Applicant: Samsung Display Co., Ltd., Yongin-si (KR)

(72) Inventor: Min Wook PARK, Asan-si (KR)

(21) Appl. No.: 14/936,162

(22) Filed: Nov. 9, 2015

(30) Foreign Application Priority Data
Jan. 16, 2015 (KR) 10-2015-0008149

(51) Int. Cl. G02F 1/1337; G02F 1/1335; G02F 1/1339; G02F 1/1343

(52) U.S. Cl. CPC G02F 1/133753; G02F 1/134336; G02F 1/133512; G02F 1/133514; G02F 1/1339; G02F 2001/133742; G02F 2001/133757; G02F 2001/134345

(57) ABSTRACT

A curved liquid crystal display that is bent in a first direction and including a plurality of pixel areas includes: a first substrate and a second substrate facing each other; a pixel electrode provided in the plurality of pixel areas on the first substrate; a first alignment layer provided on the pixel electrode and optically aligned in a direction perpendicular to the first direction; a common electrode provided on the second substrate; a second alignment layer provided on the common electrode and optically aligned in a direction parallel to the first direction; and a liquid crystal layer provided between the first substrate and the second substrate.

### CROSS-REFERENCE TO RELATED APPLICATION

This application claims priority to and the benefit of Korean Patent Application No. 10-2015-0008149 filed in the Korean Intellectual Property Office on Jan. 16, 2015, the entire contents of which are incorporated herein by reference.

### BACKGROUND

(a) Technical Field

The present disclosure relates to a curved liquid crystal display, and particularly to a curved liquid crystal display for preventing a change of a characteristic caused by misaligning an upper panel and a lower panel.

(b) Description of the Related Art

A liquid crystal display, which is one of flat panel displays most widely used today, includes two display panels on which electric field generating electrodes such as a pixel electrode and a common electrode are formed, and a liquid crystal layer inserted therebetween. The liquid crystal display displays an image by generating an electric field on a liquid crystal layer by applying a voltage to the electric field generating electrodes, determining alignments of liquid crystal molecules of the liquid crystal layer through the generated electric field, and controlling polarization of incident light.

The two display panels configuring the liquid crystal display may include a thin film transistor array panel and an opposing display panel. In the thin film transistor array panel, a gate line transferring a gate signal and a data line transferring a data signal are formed to cross each other, and a thin film transistor connected with the gate line and the data line, a pixel electrode connected with the thin film transistor, and the like may be formed. A light blocking member, a color filter, a common electrode, and the like may be formed on the opposing display panel. In some cases, the light blocking member, the color filter, and the common electrode may be formed on the thin film transistor array panel.

Recently, the liquid crystal displays have been becoming wider, and curved displays are being developed to enhance viewers' immersive experience.

The curved liquid crystal display may be realized by forming components on two display panels, attaching the display panels together to prepare a flat-panel liquid crystal display, and then bending it. In this instance, the two display panels may be misaligned from each other to change an alignment characteristic, mix colors, or deteriorate transmittance.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a curved liquid crystal display for preventing a change of a characteristic caused by misaligning an upper panel and a lower panel.

An exemplary embodiment provides a curved liquid crystal display that is bent in a first direction and including a plurality of pixel areas, including: a first substrate and a second substrate facing each other; a pixel electrode provided in the plurality of pixel areas on the first substrate; a first alignment layer provided on the pixel electrode and optically aligned in a direction perpendicular to the first direction; a common electrode provided on the second substrate; a second alignment layer provided on the common electrode and optically aligned in a direction parallel to the first direction; and a liquid crystal layer provided between the first substrate and the second substrate.

The pixel area is divided into at least four regions by a horizontal center line and a vertical center line, and the four regions include a top left region, a top right region, a bottom right region, and a bottom left region. The four regions have different liquid crystal tilt directions.

The first alignment layer is optically aligned in a second direction perpendicular to the first direction in the top right region and the bottom right region, and the first alignment layer is optically aligned in an opposite direction of the second direction in the top left region and the bottom left region.

The second alignment layer is optically aligned in the first direction in the bottom left region and the bottom right region, and the second alignment layer is optically aligned in an opposite direction to the first direction in the top left region and the top right region.

The pixel area includes a first sub-pixel area and a second sub-pixel area, the pixel electrode includes a first sub-pixel electrode provided in the first sub-pixel area and a second sub-pixel electrode provided in the second sub-pixel area, and the first sub-pixel area and the second sub-pixel area are divided into the four regions, respectively.

The second sub-pixel electrode is formed to surround the first sub-pixel electrode.

The curved liquid crystal display further includes a color filter provided on the first substrate.

The curved liquid crystal display further includes a color filter provided on the second substrate.

The plurality of pixel areas are disposed in a matrix form, the plurality of pixel areas include a plurality of first color pixel areas, second color pixel areas, and third color pixel areas, the plurality of first color pixel areas are disposed in the first direction, the plurality of second color pixel areas are disposed in the first direction, and the plurality of third color pixel areas are disposed in the first direction.

The first color pixel area and the second color pixel area are disposed to neighbor each other in a direction perpendicular to the first direction, and the second color pixel area and the third color pixel area are disposed to neighbor each other in the direction perpendicular to the first direction.

The plurality of pixel areas are formed as rectangles including two long sides and two short sides, and the long sides are parallel to the first direction.

The curved liquid crystal display further includes a light blocking member provided on the second substrate, wherein the light blocking member is provided on a boundary among the plurality of pixel areas.

The light blocking member is formed in the first direction.

The light blocking member is not provided on the boundary among the plurality of pixel areas neighboring in the first direction, but is provided on the boundary among the plurality of pixel areas neighboring in the direction perpendicular to the first direction.

The pixel area is divided into four regions by three lines in the first direction, and the four regions are divided into a top region, a middle top region, a middle bottom region, and a bottom region.

The first alignment layer is optically aligned in a second direction perpendicular to the first direction in the middle top region and the middle bottom region, and the first alignment layer is optically aligned in an opposite direction of the second direction in the top region and the bottom region.

The second alignment layer is optically aligned in the first direction in the middle bottom region and the bottom region, and the second alignment layer is optically aligned in an opposite direction of the first direction in the top region and the middle top region.

The pixel area includes a first sub-pixel area and a second sub-pixel area, the pixel electrode includes a first sub-pixel electrode provided in the first sub-pixel area and a second sub-pixel electrode provided in the second sub-pixel area, and the first sub-pixel area and the second sub-pixel area are divided into the four regions, respectively.

The second sub-pixel electrode is formed to surround the first sub-pixel electrode.

The curved liquid crystal display further includes a spacer provided on the first substrate.

The curved liquid crystal display according to the exemplary embodiment of the present invention has a following effect.

The curved liquid crystal display allows the optical alignment direction of the alignment layer formed on the upper panel to be provided in parallel with the curvature direction thereby maintaining the alignment characteristic when the upper panel is misaligned with the lower panel.

### BRIEF DESCRIPTION OF THE DRAWINGS

FIG. 1 shows a perspective view of a curved liquid crystal display according to an exemplary embodiment.

FIG. 2 shows a circuit diagram of a pixel of a curved liquid crystal display according to an exemplary embodiment.

FIG. 3 shows a top plan view of a pixel of a curved liquid crystal display according to an exemplary embodiment.

FIG. 4 shows a cross-sectional view of a curved liquid crystal display according to an exemplary embodiment with respect to a line IV-IV of FIG. 3.

FIG. 5 shows a top plan view of a direction in which liquid crystal molecules are slanted in a pixel area of a curved liquid crystal display according to an exemplary embodiment.

FIGS. 6A and 6B show a schematic diagram for showing two masks used for an optical alignment process.

FIGS. 7A and 7B show a schematic diagram for showing a method for irradiating beams by use of a mask of FIG. 6A or FIG. 6B.

FIGS. 8A, 8B, and 8C show an aligning direction of an alignment layer and a direction in which liquid crystal molecules are tilted.

FIG. 9 shows a cross-sectional view of a curved liquid crystal display according to an exemplary embodiment.

FIG. 10 shows a top plan view of a curved liquid crystal display according to an exemplary embodiment.

FIG. 11 shows a cross-sectional view of a curved liquid crystal display according to an exemplary embodiment with respect to a line XI-XI of FIG. 10.

FIG. 12 shows a top plan view of a curved liquid crystal display according to another exemplary embodiment.

FIG. 13 shows a top plan view of a curved liquid crystal display according to an exemplary embodiment.

FIG. 14 shows a cross-sectional view of a curved liquid crystal display according to an exemplary embodiment with respect to a line XIV-XIV of FIG. 13.

FIG. 15 shows a cross-sectional view of a curved liquid crystal display according to another exemplary embodiment.

FIG. 16A, FIG. 16B, and FIG. 16C show alignment directions of an alignment layer and a direction in which liquid crystal molecules are tilted in a curved liquid crystal display according to an exemplary embodiment.

### DETAILED DESCRIPTION OF THE EMBODIMENTS

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a laver, film, region, or substrate is referred to as being “on” another element, it can be directly on the other element or intervening elements may also be present. In contrast, when an element is referred to as being “directly on” another element, there are no intervening elements present.

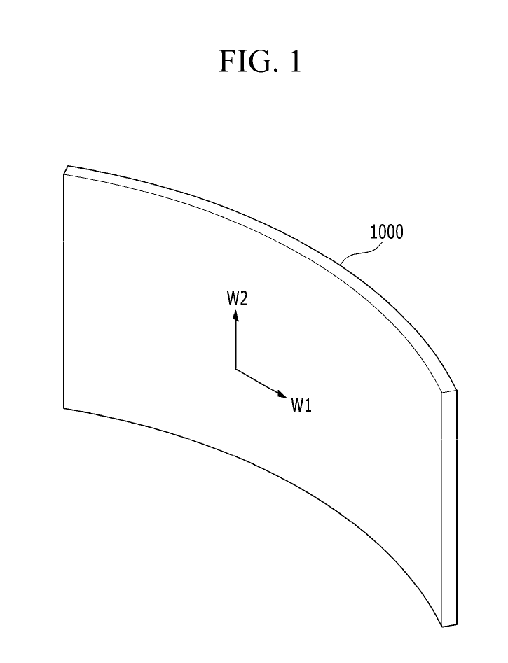

A curved liquid crystal display according to an exemplary embodiment of the will now be described with reference to FIG. 1.

FIG. 1 shows a perspective view of a curved liquid crystal display according to an exemplary embodiment.

As shown in FIG. 1, the curved liquid crystal display 1000 is bent with a predetermined curvature. The curved liquid crystal display 1000 is bent in a first direction W1. The curved liquid crystal display 1000 is formed by manufacturing a flat liquid crystal display and bending the same.

Regarding the flat liquid crystal display, the distance from the viewer's eye to a plurality of pixels included in the display device varies. For example, the distance from the viewer's eye to pixels on the left and right edges of a flat display device may be longer than the distance from the viewer's eve to pixels at the center of the flat-panel display device. On the contrary, in the curve liquid crystal display 1000 according to an exemplary embodiment of the present invention, the distance from the viewer's eye to a plurality of pixels is nearly constant, provided that the viewer's eye is at the center of a circle formed by extending the curve. Since such a curved liquid crystal display provides a wider viewing angle than flat-panel display devices, photoreceptor cells are stimulated by more information, sending more visual information to the brain via the optic nerve. As such, the sense of reality and immersion can be heightened.

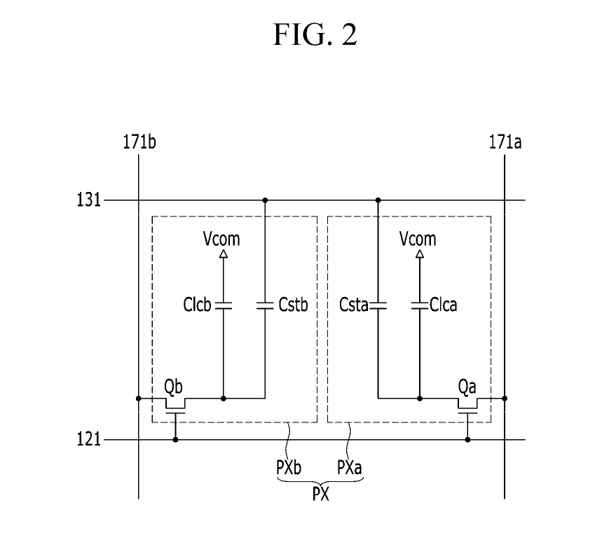

The curved liquid crystal display 1000 includes a plurality of pixel areas. A pixel of the curved liquid crystal display 1000 will now be described with reference to FIG. 2 to FIG. 4.

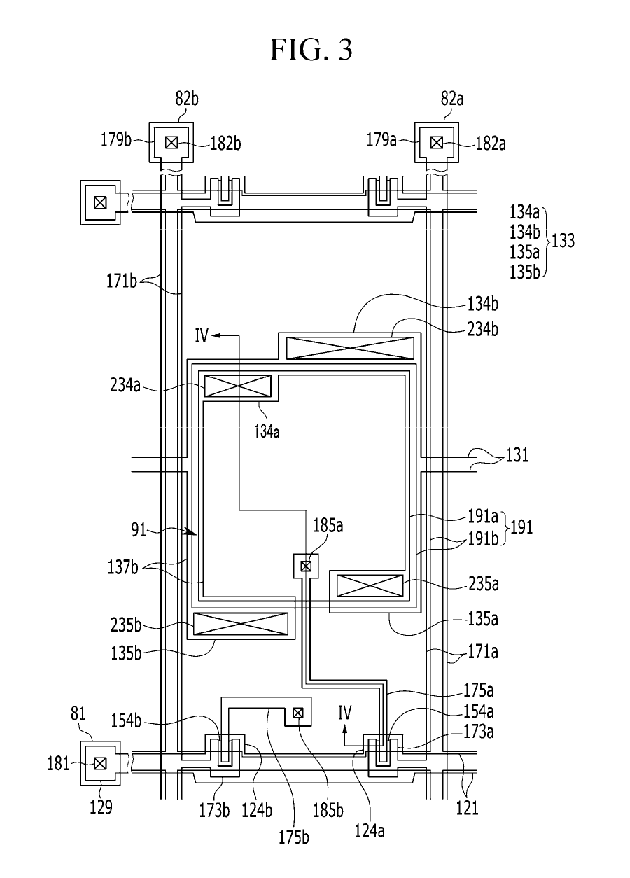

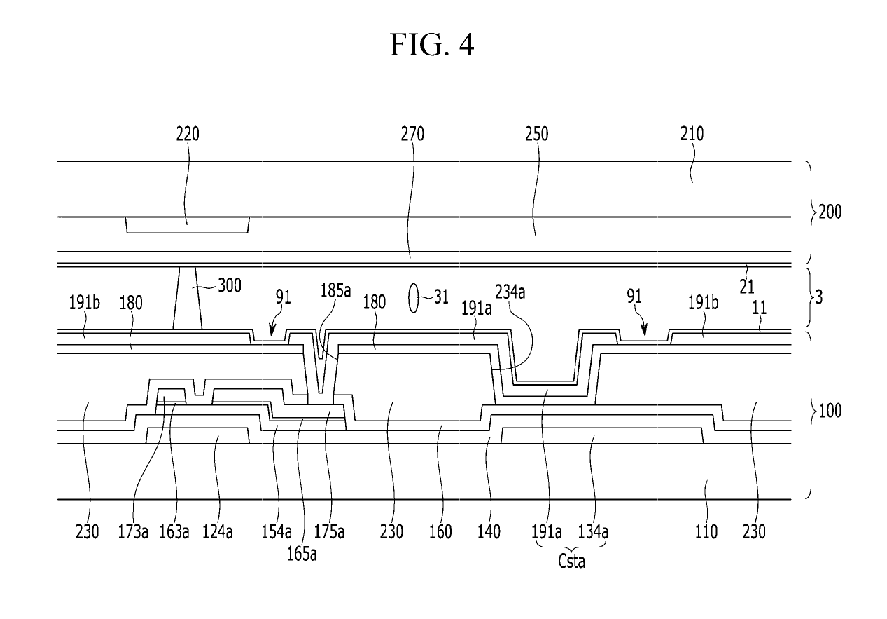

FIG. 2 shows a circuit diagram of a pixel of a curved liquid crystal display according to an exemplary embodiment. FIG. 3 shows a top plan view of a pixel of a curved liquid crystal display according to an exemplary embodiment, and FIG. 4 shows a cross-sectional view of a curved liquid crystal display according to an exemplary embodiment with respect to a line IV-IV of FIG. 3.

Referring to FIG. 2, each pixel area PX includes a first sub-pixel area (PXa) and a second sub-pixel area (PXb). The first sub-pixel area (PXa) and the second sub-pixel area (PXb) respectively include: switching elements (Qa, Qb) connected to a gate line 121 and corresponding data lines 171a and 171b, liquid crystal capacitors (Clca, Clcb) connected thereto, and storage capacitors (Csta, Cstb) connected to the switching elements (Qa, Qb) and a storage electrode line 131.

The switching elements (Qa, Qb) are respectively a three-terminal element including a control terminal, an input terminal, and an output terminal, and the control terminal is connected to the gate line 121, the input terminal is connected to the corresponding data lines 171a and 171b, and the output terminal is connected to the liquid crystal capacitors (Clca, Clcb) and the storage capacitors (Csta, Cstb).

The storage capacitors (Csta, Cstb) for supporting the liquid crystal capacitors (Clca, Clcb) are formed when the storage electrode line 131 overlaps the pixel electrode (not shown) with an insulator provided therebetween, and a predetermined voltage such as a common voltage Vcom is applied to the storage electrode line 131. However, the storage capacitors (Csta, Cstb) may be formed when the pixel electrode overlaps the previous gate line with the insulator as a medium.

Referring to FIG. 3 and FIG. 4, the liquid crystal display includes a lower panel 100 and an upper panel 200 facing each other, and a liquid crystal layer 3 provided therebetween.

The lower panel 100 will now be described.

A gate conductor including a gate line 121 and a storage electrode line 131 is formed on a first substrate 110.

The gate line 121 is generally extended in a horizontal direction and transmits a gate signal. The extending direction of the gate line 121 may be parallel with the first direction W1. The gate line 121 includes a first gate electrode 124a and a second gate electrode 124b extending upward, and a wide end portion 129.

The storage electrode line 131 generally extends in the horizontal direction and transmits a common voltage. The storage electrode line 131 is provided between two gate lines 121 and includes a storage electrode 133.

The storage electrode 133 has a belt shape including a top side, a bottom side, a left side, and a right side. The top side of the storage electrode 133 includes an extended portion 134a extending downward and an extended portion 134b extending upward, and the extended portions 134a and 134b are connected to each other. The bottom side of the storage electrode 133 includes an extended portion 135b extending downward and an extended portion 135a extending upward, and the extended portions 135a and 135b are not connected to each other. Part of the storage electrode 133 is removed, and the removed portion is provided between the extended portions 135a and 135b. The top side and the bottom side of the storage electrode 133 may be wider than the left side and the right side.

A gate insulating layer 140 is formed on the gate line 121 and the storage electrode line 131.

A semiconductor stripe (not shown) is formed on the gate insulating layer 140. The semiconductor stripe generally extends in a vertical direction, and includes first and second protrusions 154a and 154b that extend toward the first and second gate electrodes 124a and 124b.

An ohmic contact stripe (not shown), a first ohmic contact island 165a, and a second ohmic contact island (not shown) are formed on the semiconductor stripe. The ohmic contact stripe includes a first protrusion 163a and a second protrusion (not shown), the first protrusion 163a and the first ohmic contact island 165a make a pair to face each other on the first protrusion 154a of the semiconductor stripe, and the second protrusion and the second ohmic contact island make a pair to face each other on the protrusion 154b of the semiconductor stripe.

First and second data lines 171a and 171b and first and second drain electrodes 175a and 175b are formed on the ohmic contact stripe and the gate insulating layer 140.

The first and second data lines 171a and 171b mainly extend in a vertical direction to cross the gate line 121 and the storage electrode line 131 and transmit a data voltage. The first data line 171a includes a first source electrode 173a extending to the first gate electrode 124a and a wide end portion 179a. The second data line 171b includes a second source electrode 173b extending to the second gate electrode 124b and a wide end portion 179b. Different voltages are supplied to the first data line 171a and the second data line 171b. A first data voltage is supplied to the first data line 171a, and a second data voltage that is less than the first data voltage is supplied to the second data line 171b.

The first drain electrode 175a faces the first source electrode 173a with respect to the first gate electrode 124a, and the second drain electrode 175b faces the second source electrode 173b with respect to the second gate electrode 124b. End portions of the first and second drain electrodes 175a and 175b are partly surrounded by bent portions of the first and second source electrodes 173a and 173b.

The semiconductor stripe has a substantially same flat shape as the first and second data lines 171a and 171b and the first and second drain electrodes 175a and 175b except a channel region between the first source electrode 173a and the first drain electrode 175a and a channel region between the second source electrode 173b and the second drain electrode 175b.

The ohmic contact stripe is provided between the semiconductor stripe and the first and second data lines 171a and 171b, and has a substantially same flat shape as the first and second data lines 171a and 171b. The first and second ohmic contact islands are provided between the semiconductor stripe and the first and second drain electrodes 175a and 175b and have a substantially same flat shape as the first and second drain electrodes 175a and 175b.

A blocking layer 160 made of an inorganic insulating material such as a silicon nitride (SiNx) or a silicon oxide (SiOx) is formed on the first and second data lines 171a and 171b and the first and second drain electrodes 175a and 175b, and a color filter 230 is formed on the blocking layer 160. The blocking layer 160 may be omitted depending on the cases.

The color filter 230 may include a red filter, a green filter, and a blue filter extending in parallel with the first and second data lines 171a and 171b along a pixel column. In addition, the red filter, the green filter, and the blue filter may be alternately arranged for each pixel.

The color filter 230 includes a plurality of openings 234a, 234b, 235a, and 235b. The openings 234a, 234b, 235a, and 235b overlap the extended portions 134a, 134b, 135a, and 135b of the storage electrode 133.

A passivation layer 180 is formed on the color filter 230. The passivation layer 180 may be made of an inorganic insulating material such as a silicon nitride or a silicon oxide, and it prevents floating of the color filter 230 and an inflow of a chemical liquid such as an etchant into the color filter 230 in a subsequent process. The passivation layer 180 may be omitted if appropriate.

Contact holes 185a and 185b for exposing first and second drain electrodes 175a and 175b are formed in the passivation layer 180, the color filter 230, and the blocking layer 160, contact holes 182a and 182b for exposing end portions 179a and 179b of the first and second data lines 171a and 171b are formed in the passivation layer 180 and the blocking layer 160, and a contact hole 181 for exposing an end portion 129 of the gate line 121 is formed in the passivation layer 180, the blocking layer 160, and the gate insulating layer 140.

A pixel electrode 191 and a plurality of contact assistants 81, 82a, and 82b are formed on the passivation layer 180.

The pixel electrode 191 includes a first sub-pixel electrode 191a and a second sub-pixel electrode 191b that are separated with a gap 91 therebetween.

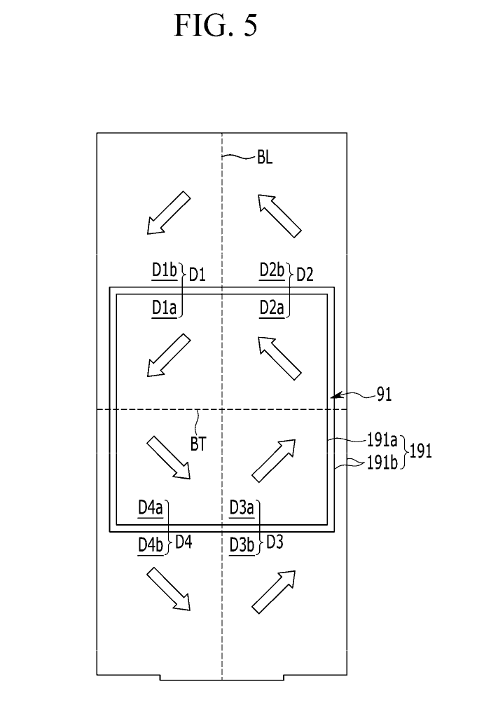

The gap 91 between the first sub-pixel electrode 191a and the second sub-pixel electrode 191b has a quadrangular frame shape, as shown in FIG. 5. The storage electrode 133 having an approximately quadrangular frame shape (see, for example, FIG. 3) overlaps the gap 91 to prevent light leakage between the first sub-pixel electrode 191a and the second sub-pixel electrode 191b.

The extended portions 134a, 135a, 134b, and 135b of the storage electrode 133 overlap the first sub-pixel electrode 191a or the second sub-pixel electrode 191b to form a storage capacitor (Cst).

That is, the first sub-pixel electrode 191a overlaps the extended portions 134a and 135a of the storage electrode 133 to form the storage capacitor (Csta). In this instance, the openings 234a and 235a of the color filter 230 are provided in a portion where the first sub-pixel electrode 191a overlaps the extended portions 134a and 135a of the storage electrode 133 thereby reducing a thickness of the insulator of the storage capacitor (Csta) and increasing storage capacitance.

The second sub-pixel electrode 191b overlaps the extended portions 134b and 135b of the storage electrode 133 to form a storage capacitor (Cstb). In this instance, the openings 234b and 235b of the color filter 230 are provided in a portion where the second sub-pixel electrode 191b overlaps the extended portions 134b and 135b of the storage electrode 133 thereby reducing a thickness of the insulator of the storage capacitor (Cstb) and increasing storage capacitance.

The first gate electrode 124a, the first protrusion 154a of the semiconductor stripe, the first source electrode 173a, and the first drain electrode 175a form a first thin film transistor Qa, and the first thin film transistor Qa is connected to the first sub-pixel electrode 191a through the contact hole 185a. The second gate electrode 124b, the second protrusion 154b of the semiconductor stripe, the second source electrode 173b, and the second drain electrode 175b form a second thin film transistor Qb, and the second thin film transistor Qb is connected to the second sub-pixel electrode 191b through the contact hole 185b.

As described above, the first sub-pixel electrode 191a and the second sub-pixel electrode 191b configuring one pixel electrode 191 are connected to the first thin film transistor Qa and the second thin film transistor Qb respectively, so the first and second sub-pixel electrodes 191a and 191b receive another data voltage through the first and second data lines 171a and 171b. Differing from this, the first and second sub-pixel electrodes 191a and 191b may receive other data voltages through one data line at different times.

When the voltage at the first sub-pixel electrode 191a is different from the voltage at the second sub-pixel electrode 191b, the voltage for the first liquid crystal capacitor (Clca) formed between the first sub-pixel electrode 191a and the common electrode 270 is different from the voltage for the second liquid crystal capacitor (Clcb) formed between the second sub-pixel electrode 191b and the common electrode 270, a slanted angle of the liquid crystal molecules of the first subpixel is different from a slanted angle of the liquid crystal molecules of the second subpixel, and luminance of the two subpixels becomes different. Therefore, when the voltage of the first liquid crystal capacitor (Clca) and the voltage of the second liquid crystal capacitor (Clcb) are appropriately controlled, the image viewed from the side may become the closest the image viewed from the front, that is, a lateral gamma curve may become the closest to a front gamma curve, and lateral visibility may be accordingly improved.

The contact assistants 81, 82a, and 82b are connected to the end portion 129 of the gate line 121 and the end portions 179a and 179b of the data lines 171a and 171b through the contact holes 181, 182a, and 182b. The contact assistants 81, 82a, and 82b support adhesiveness with external devices such as the end portion 129 of the gate line 121, the end portions 179a and 179b of the data lines 171a and 171b, and a driver IC, and protect the same.

The lower panel 100 may further include a spacer 300 provided on the first substrate 110, and may maintain the space between the lower panel 100 and the upper panel 200. The spacer 300 may be formed on the upper panel 200, and may be more desirably formed on the lower panel 100 so as to prevent deterioration of transmittance by the spacer 300 when the lower panel is misaligned from the upper panel.

The upper panel 200 will now be described.

A plurality of light blocking members 220 are formed on a second substrate 210, an overcoat 250 is formed on the light blocking member 220, and a common electrode 270 is formed on the overcoat 250.

The light blocking member 220 may overlap the gate line 121, the data lines 171a and 171b, and the thin film transistors Q1 and Q2. The light blocking member 220 may be formed in the first direction W1 and the second direction W2.

A first alignment layer 11 and a second alignment layer 21 are formed on the sides facing the lower panel 100 and the upper panel 200. The first alignment layer 11 and the second alignment layer 21 may be formed as vertical alignment layers, and a surface of the alignment layer includes a terminal that is inclined in different directions depending on a region. The first alignment layer 11 may be provided on the pixel electrode 191 on the lower panel 100, and the second alignment layer 21 may be provided on the common electrode 270 on the upper panel 200.

The first alignment layer 11 and the second alignment layer 21 are optically aligned. One pixel region is divided into a plurality of regions that have respective alignment directions. The first alignment layer 11 and the second alignment layer 21 may be formed with a polyamic acid or a polyimide including a photosensitive group such as cinnamate, chalcone, or coumarin. The optical alignment method radiates beams to the vertical alignment layer in an oblique manner to allow a photo-reactive chain on the surface of the alignment layer to be inclined in the direction of radiation. Beams may be radiated in different directions for the respective regions.

The liquid crystal layer 3 is provided between the lower panel 100 and the upper panel 200. The liquid crystal layer 3 may include a plurality of liquid crystal molecules 31 with negative dielectric anisotropy.

Directions in which the liquid crystal molecules 31 are tilted are determined by the alignment directions of the first alignment layer 11 and the second alignment layer 21. The directions in which the liquid crystal molecules 31 are tilted for the respective regions will now be described with reference to FIG. 5.

FIG. 5 shows a top plan view of a direction in which liquid crystal molecules are tilted in a pixel area of a curved liquid crystal display according to an exemplary embodiment. FIG. 5 also shows a pixel electrode.

A pixel area PX includes a first sub-pixel area (PXa) and a second sub-pixel area (PXb). The first sub-pixel electrode 191a is provided in the first sub-pixel area (PXa), and the second sub-pixel electrode 191b is provided in the second sub-pixel area (PXb). The first sub-pixel area (PXa) is provided in a center of the pixel area PX, and the second sub-pixel area (PXb) is provided to surround the first sub-pixel area (PXa). Particularly, most of the second sub-pixel area (PXb) is provided at an upper side and a lower side of the first sub-pixel area (PXa). The second sub-pixel electrode 191b is provided to surround the first sub-pixel electrode 191a. However, disposition forms of the first sub-pixel area (PXa) and the second sub-pixel area (PXb) are not restricted to the above-described form and may be variable in many ways. Further, one pixel area PX may not be divided into a plurality of sub-pixel areas, but one pixel electrode may be formed in one pixel area PX.

The first sub-pixel area (PXa) and the second sub-pixel area (PXb) are divided into at least four regions D1 (D1a, D1b), D2 (D2a, D2b), D3 (D3a, D3b), and D4 (D4a, D4b) by a horizontal center line (BT) and a vertical center line (BL). The four respective regions D1, D2, D3, and D4 of the sub-pixel areas (PXa, PXb) are configured with top left regions (D1a, D1b), top right regions (D2a, D2b), bottom right regions (D3a, D3b), and bottom left regions (D4a, D4b). The regions D1, D2, D3, and D4 have the horizontal center line (BT) and the vertical center line (BL) of the pixel electrode 191 as boundaries and have similar sizes.

When a potential difference is generated between the pixel electrode 191 and the common electrode 270, an electric field that is substantially perpendicular to sides of the display panels 100 and 200 is generated to the liquid crystal layer 3. In response to the electric field, a long axis of the liquid crystal molecules 31 of the liquid crystal layer 3 is tilted to be perpendicular to the direction of the electric field, and a changing degree of polarization of the light that is input to the liquid crystal layer 3 is changed by the tilt angle of the liquid crystal molecules 31. The change of polarization is indicated as a change of transmittance by a polarizer, through which the liquid crystal display displays an image.

The tilt angle of the liquid crystal molecules 31 is changeable by a characteristic of the alignment layers 11 and 21, and for example, it may be determined by irradiating ultraviolet rays (UV) with different polarization directions to the alignment layers 11 and 21 or irradiating the same in an oblique manner.

Arrows shown in the regions D1a, D1b, D2a, D2b, D3a, D3b, D4a, and D4b in FIG. 5 indicate the direction in which the liquid crystal molecules 31 are tilted. The liquid crystal molecules are tilted in the bottom left direction in the top left regions D1a and D1b. The liquid crystal molecules are tilted in the top left direction in the top right regions D2a and D2b. The liquid crystal molecules are tilted in the top right direction in the bottom right regions D3a and D3b. The liquid crystal molecules are tilted in the bottom right direction in the bottom left regions D4a and D4b.

However, the tilt direction of the liquid crystal molecules 31 in the respective regions D1a, D1b, D2a, D2b, D3a, D3b, D4a, and D4b are not restricted to the above description, and it may be formed by various types of combinations. Further, the sub-pixel areas PXa and PXb may be divided into more than four regions.

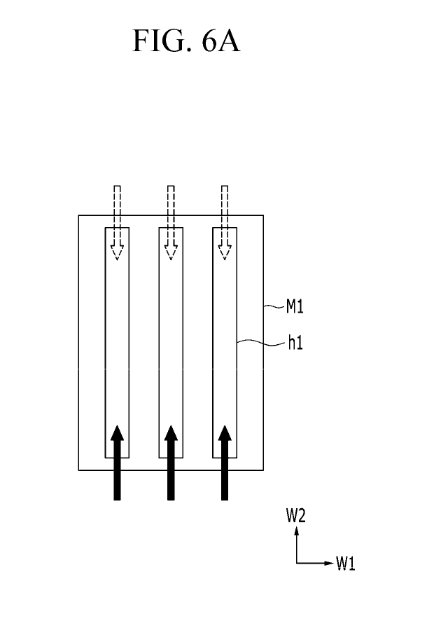

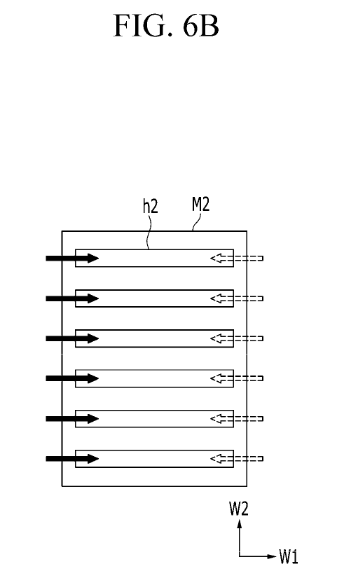

A method for optically aligning a first alignment layer and a second alignment layer and determining a direction in which liquid crystal molecules are tilted will now be described with reference to FIGS. 6A, 6B, 7, 8A, 8B, and 8C.

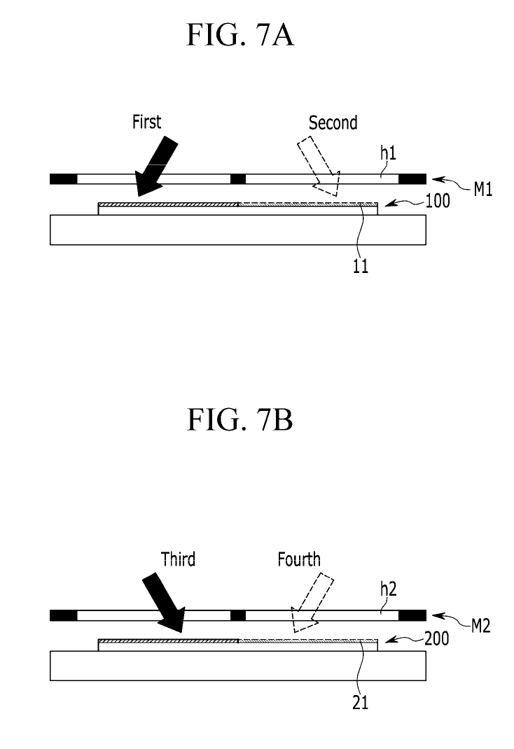

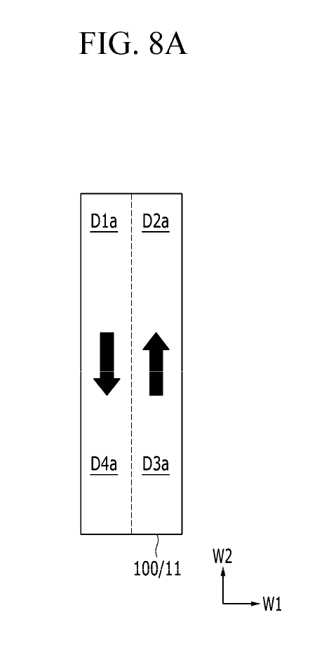

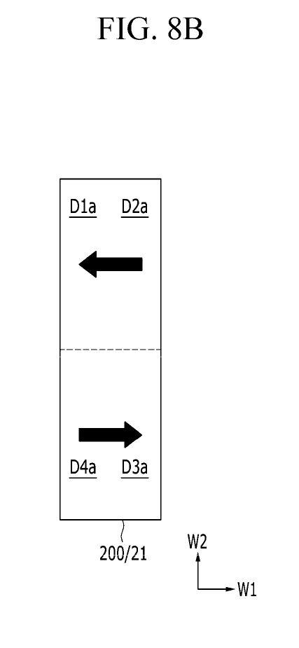

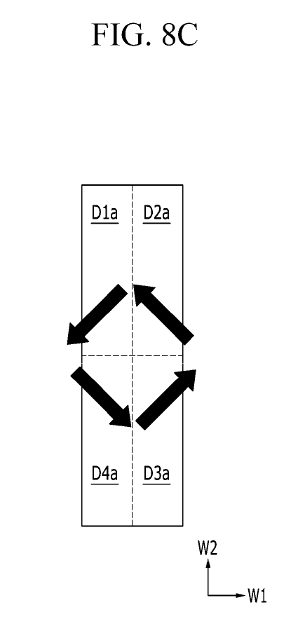

FIGS. 6A and 6B show a schematic diagram for showing two masks used for an optical alignment process, FIGS. 7A and 7B show a schematic diagram for showing a method for irradiating beams by use of a mask of FIG. 6A/B, and FIGS. 8A, 8B, and 8C show an aligning direction of an alignment layer and a direction in which liquid crystal molecules are tilted. FIGS. 8A, 8B, and 8C show a first sub-pixel area among two sub-pixel areas, and the optical alignment also occurs in the second sub-pixel area in a like manner.

Referring to FIGS. 6A and 6B, a mask used for optical alignment may be configured with a first mask M1 and a second mask M2. A plurality of openings hi are formed in the first mask M1 in a second direction W2 that is perpendicular to a first direction W1. The first direction W1 is a curvature direction of the curved liquid crystal display according to an exemplary embodiment. A plurality of openings h2 are formed in the second mask M2 in a direction parallel to the first direction W1.

Referring to FIG. 6A and FIG. 7A, the first mask M1 is disposed on the lower panel 100 on which the first alignment layer 11 is coated, and beams such as ultraviolet rays (UV) are irradiated in an oblique manner, thereby performing a first exposure process. Here, an irradiation wavelength of the ultraviolet rays (UV) is 10 nm-400 nm, and it may desirably be 280 nm-340 nm. Optical irradiation energy may be 1 mJ-5000 mJ. The optical irradiation energy and the irradiation wavelength may be selected based on the composition of the alignment layers 11 and 21. When the alignment layer is formed with a polyamic acid or a polyimide including a photosensitive group such as cinnamate, chalcone, or coumarin, the optical irradiation energy may be less than 50 mJ.

Linearly polarized ultraviolet (LPUV) rays or partially polarized rays are irradiated. The linear polarization method irradiates the beams with an oblique angle with respect to the surface of the alignment layer to generate a similar effect as if the surface of the alignment layer were rubbed in a predetermined direction. The linear polarization method inclines the alignment layer or a linear polarization irradiation device. The irradiation slope may be 0 to 90 degrees, and desirably 20 to 70 degrees. The beams such as the ultraviolet rays (UV) are obliquely irradiated in a direction that is opposite the first exposure direction, thereby performing a second exposure process.

In this instance, the beams are irradiated in a direction parallel to the long axis of the opening h1 of the first mask M1, that is, the second direction W2. If not, the region actually exposed by optical diffraction may be reduced and a processing margin for a distance between the substrate and the mask and an exposure angle may be reduced.

The liquid crystal molecule tilt angle is given from top to bottom in the left portion of the pixel area and it is given from bottom to top in the right portion thereof, thereby forming two regions with opposite tilt angles as shown in FIG. 8A.

The first alignment layer 11 is optically aligned in the second direction W2 that is perpendicular to the first direction W1 in the top right region (D2a) and the bottom right region (D3a) of the first sub-pixel area (PXa), and it is optically aligned in an opposite direction −W2 of the second direction W2 in the top left region (D1a) and the bottom left region (D4a).

In a like manner, referring to FIG. 6B and FIG. 7B, the second mask M2 is disposed on the upper panel 200 on which the second alignment layer 21 is coated, and the beams such as ultraviolet rays (UV) are obliquely irradiated, thereby performing a third exposure process. A fourth exposure process is performed by obliquely irradiating the beams such as the ultraviolet rays (UV) in an opposite direction of the third exposure direction.

Here, the beams are irradiated in the direction in parallel to the long axis of the opening h2 of the mask M2, that is, the first direction W1.

For example, the tilt direction is given from right to left in the top portion of the pixel area and it is given from left to right in the bottom portion thereof, thereby forming two regions with opposite tilt directions as shown in FIG. 8B.

As shown in FIG. 8B, the second alignment layer 21 is optically aligned in the first direction W1 in the bottom left region (D4a) and the bottom right region (D3a) of the first sub-pixel area (PXa), and it is optically aligned in the opposite direction −W1 of the first direction W1 in the top left region (D1a) and the top right region (D2a).

The beams are irradiated with an oblique angle with respect to the surface of the alignment layer to generate a similar effect as when the surface of the alignment layer is rubbed in a predetermined direction. That is, the alignment direction of the surface of the alignment layer is changed according to the beam irradiation direction so a plurality of domains with different pretilt angles of liquid crystal molecules may be formed on one pixel by dividing one pixel into a plurality of regions and performing an exposure process.

Referring to FIG. 8C, when the lower panel 100 is bonded to the upper panel 200, the tilt angles of the liquid crystal molecules are determined in the respective regions D1a, D2a, D3a, and D4a by a vector sum of the alignment directions of the first alignment layer 11 and the second alignment layer 21. For example, the first alignment layer 11 of the lower panel 100 has an alignment direction from top to bottom in the top left region (D1a), and the second alignment layer 21 of the upper panel 200 has an alignment direction from right to left. Therefore, the liquid crystal molecules are tilted in the bottom left direction by the vector sum in the top left region (D1a).

In the present exemplary embodiment, the first alignment layer is optically aligned in a direction perpendicular to the curvature direction of the curved liquid crystal display, and the second alignment layer is optically aligned in the direction parallel to the curvature direction. Alternatively, it may be assumed that the first alignment layer is optically aligned in the direction parallel to the curvature direction, and the second alignment layer is optically aligned in a direction perpendicular to the curvature direction. The lower panel and the upper panel may become misaligned when the lower panel is bonded to the upper panel, the two panels are bent together, and they are formed into a curved liquid crystal display. The vertical center line of the pixel area may shift during this process, changing sizes of the top left region, the top right region, the bottom right region, and the bottom left region. That is, the sizes of a plurality of regions are different in the curved liquid crystal display on which second alignment layer is optically aligned in a different direction from the curvature direction.

In the present exemplary embodiment, the second alignment layer is optically aligned in the direction parallel to the curvature direction. As a result, when the lower panel and the upper panel get misaligned, the vertical center line of the pixel area does not move. The sizes of the top left region, the top right region, the bottom right region, and the bottom left region may be maintained. That is, the alignment characteristic may be maintained when the lower panel shifts with respect to the upper panel.

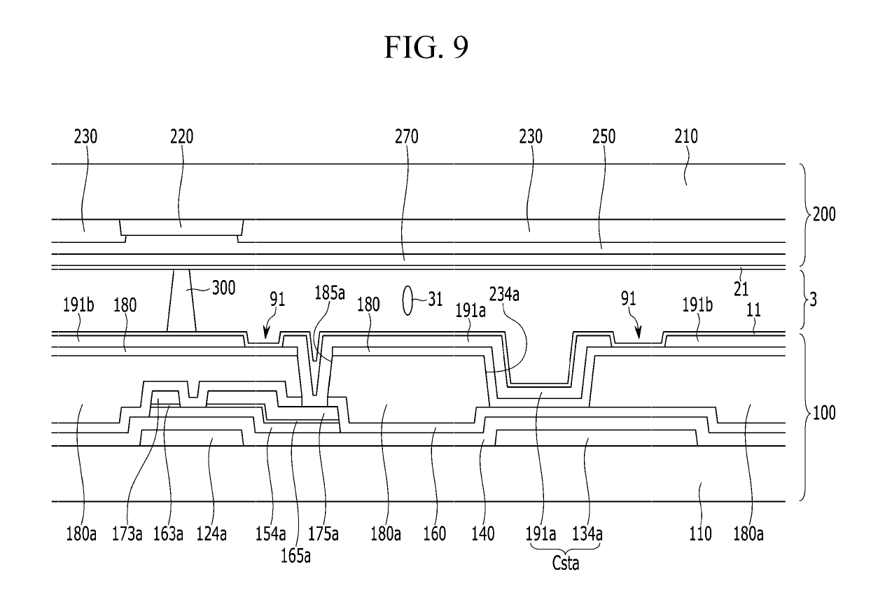

A curved liquid crystal display according to an exemplary embodiment of the will now be described with reference to FIG. 9 to FIG. 11.

The curved liquid crystal display according to an exemplary embodiment shown in FIG. 9 to FIG. 11 mostly corresponds to the curved liquid crystal display according to an exemplary embodiment described with reference to FIG. 1 to FIG. 8 so no corresponding descriptions will be provided. The present exemplary embodiment is different from the previous exemplary embodiment in that the color filter is formed on the upper panel, which will now be described.

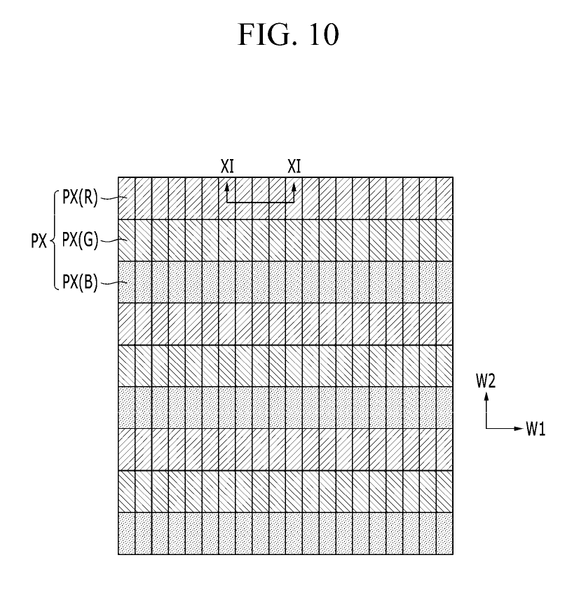

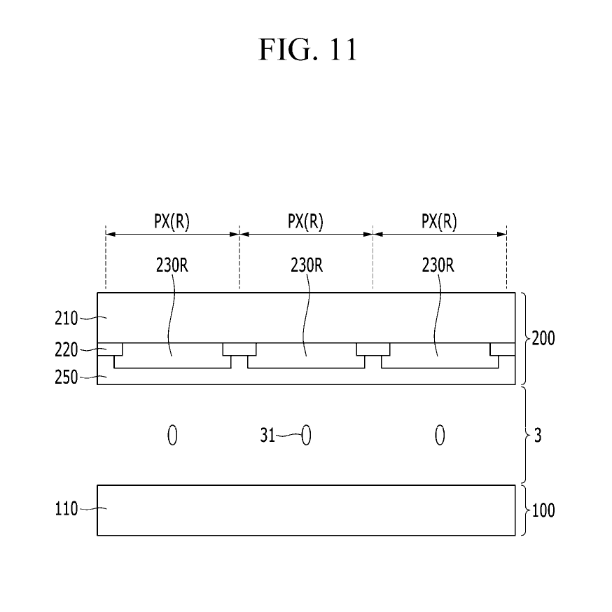

FIG. 9 shows a cross-sectional view of a curved liquid crystal display according to an exemplary embodiment, FIG. 10 shows a top plan view of a curved liquid crystal display according to an exemplary embodiment, and FIG. 11 shows a cross-sectional view of a curved liquid crystal display according to an exemplary embodiment with respect to a line XI-XI of FIG. 10. FIG. 11 shows predetermined constituent elements such as color filters, and other constituent elements are omitted.

In a like manner of the above-described exemplary embodiment, the curved liquid crystal display according to an exemplary embodiment includes a lower panel 100 and an upper panel 200 facing each other, and a liquid crystal layer 3 provided between the display panels 100 and 200. The lower panel 100 includes a pixel electrode 191 provided on the first substrate 110, and a first alignment layer 11 provided on the pixel electrode 191. The upper panel 200 includes a common electrode 270 provided on the second substrate 210, and a second alignment layer 21 provided on the common electrode 270.

The first alignment layer 11 is optically aligned in the direction perpendicular to the curvature direction of the curved liquid crystal display according to an exemplary embodiment, and the second alignment layer 21 is optically aligned in the direction parallel to the curvature direction.

A color filter 230 is formed on the lower panel 100 in the previous exemplary embodiment, but a color filter 230 is formed on the upper panel 200 in the present exemplary embodiment. The lower panel 100 may further include an insulating layer 180a made of an organic insulating material instead of the color filter. The insulating layer 180a may be provided between the blocking layer 160 and the passivation layer 180.

A plurality of pixel areas PX may be disposed in a matrix form. That is, the pixel areas PX may be disposed in a row direction and a column direction. The pixel areas PX may include a plurality of first color pixel areas PX(R), second color pixel areas PX(G), and third color pixel areas PX(B). The first color pixel area PX(R) may be formed with a red pixel region, the second color pixel area PX(G) may be formed with a green pixel region, and the third color pixel area PX(B) may be formed with a blue pixel region. A first color filter 230R is provided in the first color pixel area PX(R), a second color filter (not shown) is provided in the second color pixel area PX(G), and a third color filter (not shown) is provided in the third color pixel area PX(B).

The first color pixel areas PX(R) are disposed in the first direction W1 that is a curvature direction of the curved liquid crystal display according to an exemplary embodiment. The second color pixel areas PX(G) are disposed in the first direction W1, and the third color pixel areas PX(B) are disposed in the first direction W1. The pixel areas PX with a same color may be disposed in the row direction.

The first color pixel area PX(R) and the second color pixel area PX(G) are disposed to neighbor each other in the second direction W2 perpendicular to the first direction W1. The second color pixel area PX(G) and the third color pixel area PX(B) are disposed to neighbor each other in the second direction W2. The pixel areas PX with different colors may be disposed in the column direction.

In the present exemplary embodiment, the pixel areas with the same color are disposed in the first direction. The opposite case in which the pixel areas with different colors are disposed in the first direction may be assumed. The lower panel may be misaligned from the upper panel when the lower panel is bonded to the upper panel, they are bent, and they are realized to be a curved liquid crystal display. In this instance, the color filter included in the upper panel moves in the first direction and a plurality of color filters are provided in one pixel area to mix colors.

The pixel areas with the same color are disposed in the direction parallel to the curvature direction so no mixing of colors occurs in the present exemplary embodiment when the lower panel is misaligned from the upper panel.

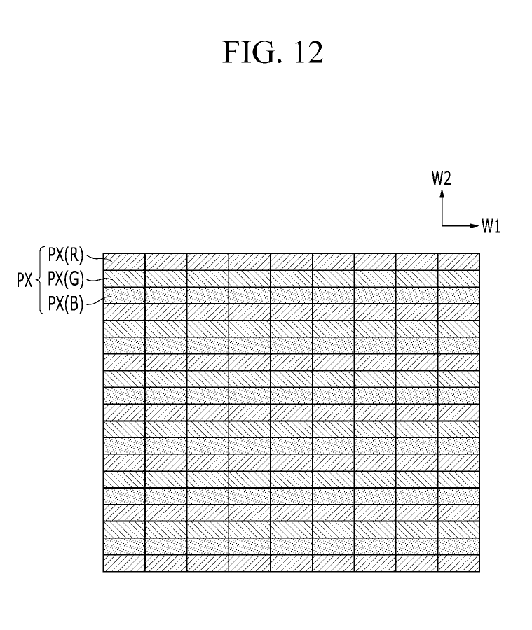

Referring to FIG. 10, the pixel area PX is configured as a rectangle including two long sides and two short sides, and the long sides are parallel to the second direction W2 that is perpendicular to the curvature direction of the curved liquid crystal display according to an exemplary embodiment of the inventive concept. However, the present exemplary embodiment is not restricted to this, and the pixel areas PX may be modified in various ways, which will now be described with reference to FIG. 12.

FIG. 12 shows a top plan view of a curved liquid crystal display according to another exemplary embodiment.

As shown in FIG. 12, the pixel area PX is configured as a rectangle including two long sides and two short sides, and the long sides are parallel with the first direction W1 that is the curvature direction of the curved liquid crystal display according to an exemplary embodiment.

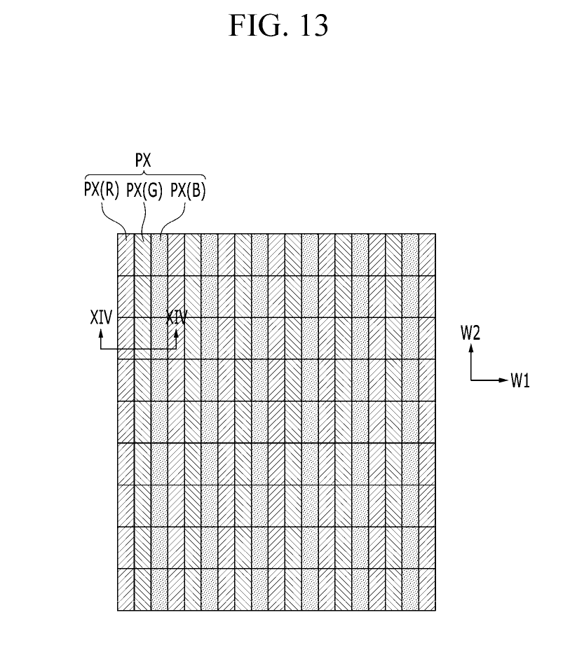

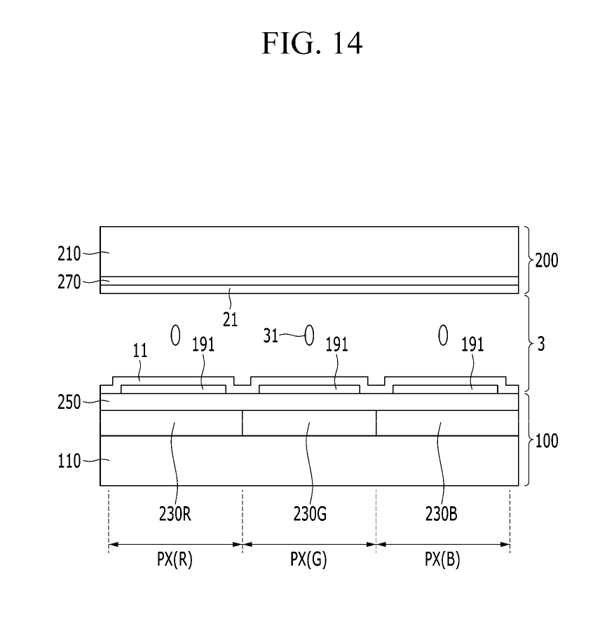

A curved liquid crystal display according to an exemplary embodiment of the inventive concept will now be described with reference to FIG. 13 and FIG. 14.

The curved liquid crystal display according to an exemplary embodiment shown in FIG. 13 and FIG. 14 mostly corresponds to the curved liquid crystal display according to an exemplary embodiment described with reference to FIG. 1 to FIG. 8, so no corresponding descriptions will be provided. The present exemplary embodiment is different from the previous exemplary embodiment primarily in that the light blocking member is formed in the first direction.

FIG. 13 shows a top plan view of a curved liquid crystal display according to an exemplary embodiment, and FIG. 14 shows a cross-sectional view of a curved liquid crystal display according to an exemplary embodiment with respect to a line XIV-XIV of FIG. 13. FIG. 14 shows predetermined constituent elements such as color filters and other constituent elements are omitted.

In a like manner of the above-described exemplary embodiment, the curved liquid crystal display according to an exemplary embodiment includes a lower panel 100 and an upper panel 200 facing each other, and a liquid crystal layer 3 provided between the display panels 100 and 200. The lower panel 100 includes a pixel electrode 191 provided on the first substrate 110, and a first alignment layer 11 provided on the pixel electrode 191. The upper panel 200 includes a common electrode 270 provided on the second substrate 210, and a second alignment layer 21 provided on the common electrode 270.

The first alignment layer 11 is optically aligned in the direction perpendicular to the curvature direction of the curved liquid crystal display according to an exemplary embodiment, and the second alignment layer 21 is optically aligned in the direction parallel to the curvature direction.

A plurality of pixel areas PX may include a plurality of first color pixel areas PX(R), second color pixel areas PX(G), and third color pixel areas PX(B). A first color filter 230R is provided in the first color pixel area PX(R), a second color filter 230G is provided in the second color pixel area PX(G), and a third color filter 230B is provided in the third color pixel area PX(B).

A light blocking member 220 is provided on the second substrate 210. The light blocking member 220 is formed in the first direction W1 and the second direction W2 in the previous exemplary embodiment, but the light blocking member 220 is formed in the first direction W1 in the present exemplary embodiment. That is, the light blocking member 220 is not formed in the second direction W2.

The light blocking member 220 is not provided on a boundary among a plurality of pixel areas PX neighboring each other in the first direction W1, and is provided on a boundary among a plurality of pixel areas PX neighboring each other in the second direction W2 perpendicular to the first direction W1.

When the light blocking member 220 is formed in the second direction W2 and the lower panel 100 is misaligned from the upper panel 200, the light blocking member 220 moves and transmittance is reduced. The reduction of transmittance is prevented by forming the light blocking member 220 in the first direction W1 in the curved liquid crystal display according to an exemplary embodiment.

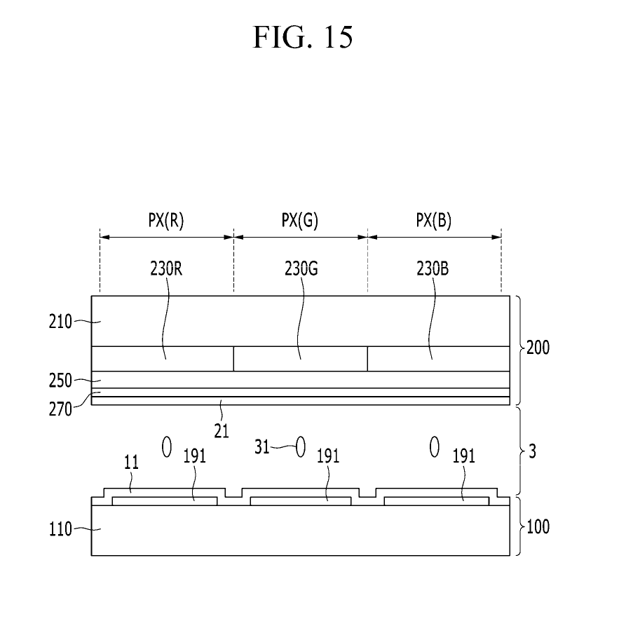

FIG. 14 shows that the first color filter 230R, the second color filter 230G, and the third color filter 230B are provided on the first substrate 110. However, the present inventive concept is not restricted thereto, and a corresponding example will now be described with reference to FIG. 15.

FIG. 15 shows a cross-sectional view of a curved liquid crystal display according to another exemplary embodiment.

As shown in FIG. 15, the first color filter 230R, the second color filter 230G, and the third color filter 230B may be provided on the second substrate 210.

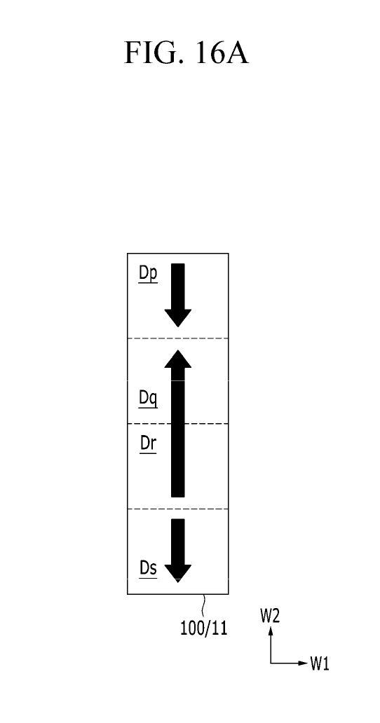

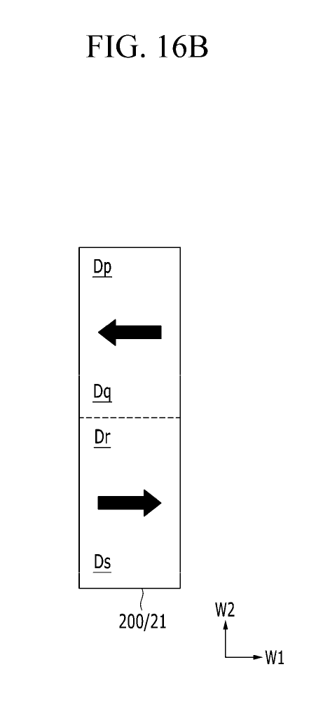

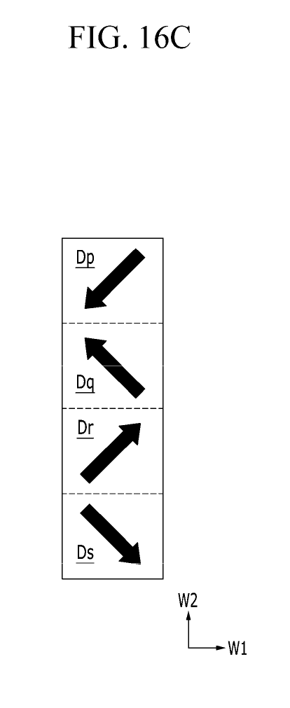

A curved liquid crystal display according to an exemplary embodiment will now be described with reference to FIG. 16.

The curved liquid crystal display according to an exemplary embodiment shown in FIG. 16 mostly corresponds to the curved liquid crystal display according to an exemplary embodiment described with reference to FIG. 1 to FIG. 8, so no corresponding descriptions will be provided. The present exemplary embodiment is different from the previous exemplary embodiment primarily in that the reference line for dividing one pixel area is parallel to the first direction.

FIG. 16 shows an aligning direction of an alignment layer and a direction in which liquid crystal molecules are tilted in a curved liquid crystal display according to an exemplary embodiment.

In a like manner of the previous exemplary embodiment, the first alignment layer 11 is optically aligned in the direction perpendicular to the curvature direction of the curved liquid crystal display according to an exemplary embodiment, and the second alignment layer 21 is optically aligned in the direction parallel to the curvature direction.

One pixel area PX is divided into a top region (Dp), a middle top region (Dq), a middle bottom region (Dr), and a bottom region (Ds) by three lines in the first direction. The regions Dp, Dq, Dr, and Ds are very similar in size. One pixel area PX may be divided into a plurality of sub-pixel areas, and each sub-pixel area may be divided into four regions Dp, Dq, Dr, and Ds.

Referring to FIG. 16 (a), the first alignment layer 11 is optically aligned in the direction perpendicular to the first direction W1 that is the curvature direction of the curved liquid crystal display according to an exemplary embodiment. The first alignment layer 11 is optically aligned in the second direction W2 perpendicular to the first direction W1 in the middle top region (Dq) and the middle bottom region (Dr), and it is optically aligned in the opposite direction −W2 from the second direction W2 in the top region (Dq) and the bottom region (Ds).

Referring to FIG. 16B, the second alignment layer 21 is optically aligned parallel to the first direction W1. The second alignment layer 21 is optically aligned in the first direction W1 in the middle bottom region (Dr) and the bottom region (Ds), and it is optically aligned in the opposite direction −W1 from the first direction W1 in the top region (Dp) and the middle top region (Dq).

Referring to FIG. 16C, when the lower panel 100 is bonded to the upper panel 200, the tilt directions of the liquid crystal molecules in the respective regions Dp, Dq, Dr, and Ds are determined by the vector sum of the alignment directions of the first alignment layer 11 and the second alignment layer 21. The liquid crystal molecules are tilted in the bottom left direction in the top region (Dp), and the liquid crystal molecules are tilted in the top left direction in the middle top region (Dq). The liquid crystal molecules are tilted in the top right direction in the middle bottom region (Dr), and the liquid crystal molecules are tilted in the bottom right direction in the bottom region (Ds).

In the present exemplary embodiment, the second alignment layer is optically aligned in the direction parallel to the curvature direction, so when the lower panel is misaligned from the upper panel, the sizes of the top region, the middle top region, the middle bottom region, and the bottom region are maintained, and the alignment characteristic is maintained.

While this invention has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims and the disclosure.

What is claimed is:

1. A curved liquid crystal display that is bent in a first direction and including a plurality of pixel areas, comprising:
a first substrate and a second substrate facing each other;
a pixel electrode provided in the plurality of pixel areas on the first substrate;
a first alignment layer provided on the pixel electrode and optically aligned in a direction perpendicular to the first direction;
a common electrode provided on the second substrate;
a second alignment layer provided on the common electrode and optically aligned in a direction parallel to the first direction; and
a liquid crystal layer provided between the first substrate and the second substrate.

2. The curved liquid crystal display of claim 1, wherein
the pixel area is divided into at least four regions by a horizontal center line and a vertical center line,
the four regions include a top left region, a top right region, a bottom right region, and a bottom left region, wherein the four regions have different liquid crystal tilt directions.

3. The curved liquid crystal display of claim 2, wherein
the first alignment layer is optically aligned in a second direction perpendicular to the first direction in the top right region and the bottom right region, and
the first alignment layer is optically aligned in an opposite direction of the second direction in the top left region and the bottom left region.

4. The curved liquid crystal display of claim 3, wherein
the second alignment layer is optically aligned in the first direction in the bottom left region and the bottom right region, and
the second alignment layer is optically aligned in an opposite direction to the first direction in the top left region and the top right region.

5. The curved liquid crystal display of claim 2, wherein
the pixel area includes a first sub-pixel area and a second sub-pixel area,
the pixel electrode includes a first sub-pixel electrode provided in the first sub-pixel area and a second sub-pixel electrode provided in the second sub-pixel area, and
the first sub-pixel area and the second sub-pixel area are divided into the four regions, respectively.

6. The curved liquid crystal display of claim 5, wherein
the second sub-pixel electrode is formed to surround the first sub-pixel electrode.

7. The curved liquid crystal display of claim 1, further comprising
a color filter provided on the first substrate.

8. The curved liquid crystal display of claim 1, further comprising
a color filter provided on the second substrate.

9. The curved liquid crystal display of claim 8, wherein
the plurality of pixel areas are disposed in a matrix form,
the plurality of pixel areas include a plurality of first color pixel areas, second color pixel areas, and third color pixel areas,
the plurality of first color pixel areas are disposed in the first direction,
the plurality of second color pixel areas are disposed in the first direction, and
the plurality of third color pixel areas are disposed in the first direction.

10. The curved liquid crystal display of claim 9, wherein
the first color pixel area and the second color pixel area are disposed to neighbor each other in a direction perpendicular to the first direction, and
the second color pixel area and the third color pixel area are disposed to neighbor each other in the direction perpendicular to the first direction.

11. The curved liquid crystal display of claim 10, wherein
the plurality of pixel areas are formed as rectangles including two long sides and two short sides, and
the long sides are parallel to the first direction.

12. The curved liquid crystal display of claim 1, further comprising
a light blocking member provided on the second substrate,
wherein the light blocking member is provided on a boundary among the plurality of pixel areas.

13. The curved liquid crystal display of claim 12, wherein
the light blocking member is formed in the first direction.

14. The curved liquid crystal display of claim 13, wherein
the light blocking member is not provided on the boundary among the plurality of pixel areas neighboring in the first direction, but is provided on the boundary among the plurality of pixel areas neighboring in the direction perpendicular to the first direction.

15. The curved liquid crystal display of claim 1, wherein
the pixel area is divided into four regions by three lines in the first direction, and
the four regions are divided into a top region, a middle top region, a middle bottom region, and a bottom region.

16. The curved liquid crystal display of claim 15, wherein
the first alignment layer is optically aligned in a second direction perpendicular to the first direction in the middle top region and the middle bottom region, and
the first alignment layer is optically aligned in an opposite direction of the second direction in the top region and the bottom region.

17. The curved liquid crystal display of claim 16, wherein
the second alignment layer is optically aligned in the first direction in the middle bottom region and the bottom region, and
the second alignment layer is optically aligned in an opposite direction of the first direction in the top region and the middle top region.

18. The curved liquid crystal display of claim 15, wherein
the pixel area includes a first sub-pixel area and a second sub-pixel area,
the pixel electrode includes a first sub-pixel electrode provided in the first sub-pixel area and a second sub-pixel electrode provided in the second sub-pixel area, and
the first sub-pixel area and the second sub-pixel area are divided into the four regions, respectively.

19. The curved liquid crystal display of claim 18, wherein
the second sub-pixel electrode is formed to surround the first sub-pixel electrode.

20. The curved liquid crystal display of claim 1, further comprising
a spacer provided on the first substrate.
